(19) United States
(12) Patent Application Publication
(10) Pub. No.: US 2010/0014121 A1
(43) Pub. Date: Jan. 21, 2010

(54) Printing Apparatus, Printing Method, and Recording Medium

(75) Inventors: Takashi HYUGA, Suwa-shi, (JP); Kimitake MIZOBE, Shiojiri-shi (JP); Nobuhiro KARITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/494,061

(22) Filed: Jun. 29, 2009

(30) Foreign Application Priority Data
Jul. 16, 2008 (JP) 2008-185241

(51) Int. Cl. H04N 1/405; G06F 15/00

(52) U.S. Cl. 358/3.06; 358/1.9

(57) ABSTRACT

There is provided a printing apparatus that prints an image constituted by a plurality of pixels. The printing apparatus includes a sum correspondence value calculating unit that calculates a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel, a rectangle sum value calculating unit that calculates a sum value within the rectangle on the basis of the sum correspondence value for adjacent pixels that are adjacent to four vertexes of an arbitrary target rectangle of the image for a target pixel located in a predetermined position within the target rectangle, an attribute determining unit that determines the attribute of the target pixel in the image based on the sum value within the rectangle for the target pixel, and a print control unit that prints image data for which image processing on the basis of the attributes of the pixels is performed.

### BACKGROUND

1. Technical Field

The present invention relates to a printing apparatus, a printing method, and a recording medium.

2. Related Art

Generally, various image processing technologies that are used in a printing process have been known. For example, technology for performing an image correcting process for outputting image data read out by a copier, an image scanner, a facsimile machine, or the like at a higher resolution has been known. In addition, related to such technology, technology for determining the attribute of an image such as a character or a halftone dot has been known.

There are related arts that have been disclosed in JP-A-4-304776 and JP-A-7-220072.

However, since many pixels are included in the image data that represents an image, the load of the process for determining the attribute of an image tends to be high. In addition, such a problem is not limited to a case where the attribute of an image is determined and is a problem that is common to a case where an image constituted by a plurality of pixels is processed.

### SUMMARY

An advantage of some aspects of the invention is that it provides technology capable of decreasing the load of image processing.

The invention may be implemented in the following forms or applied examples.

### APPLIED EXAMPLE 1

According to Applied Example 1, there is provided a printing apparatus that prints an image constituted by a plurality of pixels. The printing apparatus includes: a sum correspondence value calculating unit that calculates a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel; a rectangle sum value calculating unit that calculates a sum value within the rectangle on the basis of the sum correspondence value for adjacent pixels that are adjacent to four vertexes of an arbitrary target rectangle of the image for a target pixel located in a predetermined position within the target rectangle; an attribute determining unit that determines the attribute of the target pixel in the image based on the sum value within the rectangle for the target pixel; and a print control unit that prints image data for which image processing on the basis of the attributes of the pixels is performed.

According to the above-described printing apparatus, when the attribute of the target pixel within the target rectangle is to be determined, the sum value within the rectangle is calculated by using sum correspondence values generated for adjacent pixels that are adjacent to four vertexes of the target rectangle. Accordingly, the load of the image processing can be decreased.

### APPLIED EXAMPLE 2

In the above-described printing apparatus, the image is a rectangle, and the reference pixel is a pixel that is located in any one of the vertexes of four corners of the image.

According to the above-described printing apparatus, the attribute can be determined for all the pixels that constitute an image.

### APPLIED EXAMPLE 3

In the above-described printing apparatus, the attribute determining unit determines to which area of a plurality of types of areas, which includes at least a black character area and a halftone dot area of the image, the target pixel belongs.

According to the above-described printing apparatus, when at least pixels belonging to the black character area and pixels belonging to the halftone dot area are classified, the load of the image processing can be decreased.

Accordingly, after the classification process is performed, an appropriate process can be performed for each area of at least the black character area and the halftone dot area.

### APPLIED EXAMPLE 4

In the above-described printing apparatus, the pixel is represented by gray scale value data that has component values of R (red color), G (green color), and B (blue color), and the sum correspondence value calculating unit calculates the saturation evaluating value based on a difference of at least two component values among the component values.

According to the above-described printing apparatus, the saturation evaluating value can be acquired by performing a relatively simple process, and therefore the load of image processing can be decreased.

### APPLIED EXAMPLE 5

In the above-described printing apparatus, the sum correspondence value calculating unit calculates the saturation evaluating value based on a difference between a maximum value and a minimum value among the component values.

According to the above-described printing apparatus, when the acquired difference is small, it can be assumed that the saturation is low. Therefore, the saturation evaluating value can be acquired with high accuracy.

### APPLIED EXAMPLE 6

The above-described printing apparatus further includes a resolution acquiring unit that acquires the resolution of the image. In a case where the resolution of the image is higher than a specific value, the rectangle sum value calculating unit calculates the sum value within the rectangle by setting the number of the pixels within the target rectangular area to be larger than that for a case where the resolution of the image is lower than the specific value, based on the resolution.

According to the above-described printing apparatus, the number of pixels within the target rectangle is set in accordance with the resolution of the image, and accordingly, the size (area) of the target rectangle can be set to be in a same level regardless of the degree of the resolution. As a result, the accuracy of attribute determination can be maintained to be almost constant regardless of the read-out resolution.

### APPLIED EXAMPLE 7

According to Applied Example 7, there is provided a printing method using a printing apparatus that prints an image constituted by a plurality of pixels. The method includes: calculating a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel; calculating a sum value within the rectangle on the basis of the sum correspondence value for adjacent pixels that are adjacent to four vertexes of an arbitrary target rectangle of the image for a target pixel located in a predetermined position within the target rectangle; determining the attribute of the target pixel in the image based on the sum value within the rectangle for the target pixel; and printing image data for which image processing on the basis of the attributes of the pixels is performed.

According to the above-described image processing method, when the attribute of the target pixel located within the target rectangle is determined, the sum value within the rectangle area is acquired using the sum correspondence values acquired for the adjacent pixels that are adjacent to four vertexes of the target rectangle. Accordingly, the load of the image processing can be decreased.

### APPLIED EXAMPLE 8

According to Applied Example 8, there is provided a computer program for printing an image that is constituted by a plurality of pixels, the computer program implementing in a computer functions including: a function for calculating a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel; a function for calculating a sum value within the rectangle on the basis of the sum correspondence value for adjacent pixels that are adjacent to four vertexes of an arbitrary target rectangle within the image for a target pixel located in a predetermined position within the target rectangle; a function for determining the attribute of the target pixel in the image based on the sum value within the rectangle for the target pixel; and a function for printing image data for which image processing on the basis of the attributes of the pixels is performed.

According to the above-described computer program, when the attribute of the target pixel within the target rectangle is determined, the sum value within the rectangle is acquired using the sum correspondence values that are acquired for the adjacent pixels that are adjacent to four vertexes of the target rectangle. Therefore, the load of the image processing can be decreased.

### BRIEF DESCRIPTION OF THE DRAWINGS

The invention will be described with reference to the accompanying drawings, wherein like numbers reference like elements.

FIG. 1 is an explanatory diagram showing a schematic configuration of a printer as an image processing apparatus according to an embodiment of the invention.

FIG. 2 is a flowchart showing the sequence of an image duplicating process that is performed in the printer 10.

FIG. 3 is a flowchart showing the sequence of an area classifying process that is performed in Step S120 (FIG. 2).

FIG. 4 is an explanatory diagram schematically showing a method of generating integral data in Step S215.

FIG. 5 is an explanatory diagram schematically showing the content of a target rectangular area size table tb1.

FIGS. 6A and 6B are explanatory diagrams schematically showing methods of calculating a sum value of color differences within an area.

FIG. 7 is a flowchart showing a detailed sequence of an area determining process (Step S230) shown in FIG. 3.

FIG. 8 is an explanatory diagram showing a setting example of a threshold value 0 that is referred to in Step S505.

FIG. 9 is an explanatory diagram showing one example of the result of area classification.

FIG. 10 is a flowchart showing a detailed sequence of a correction process for each area (FIG. 2: Step S130).

FIG. 11 is an explanatory diagram showing one example of a conversion table that is used in Step S610.

FIG. 12 is an explanatory diagram showing a setting of ink types used in the printer 10.

### DESCRIPTION OF EXEMPLARY EMBODIMENTS

### A. EMBODIMENTS

### A1. CONFIGURATION OF APPARATUS

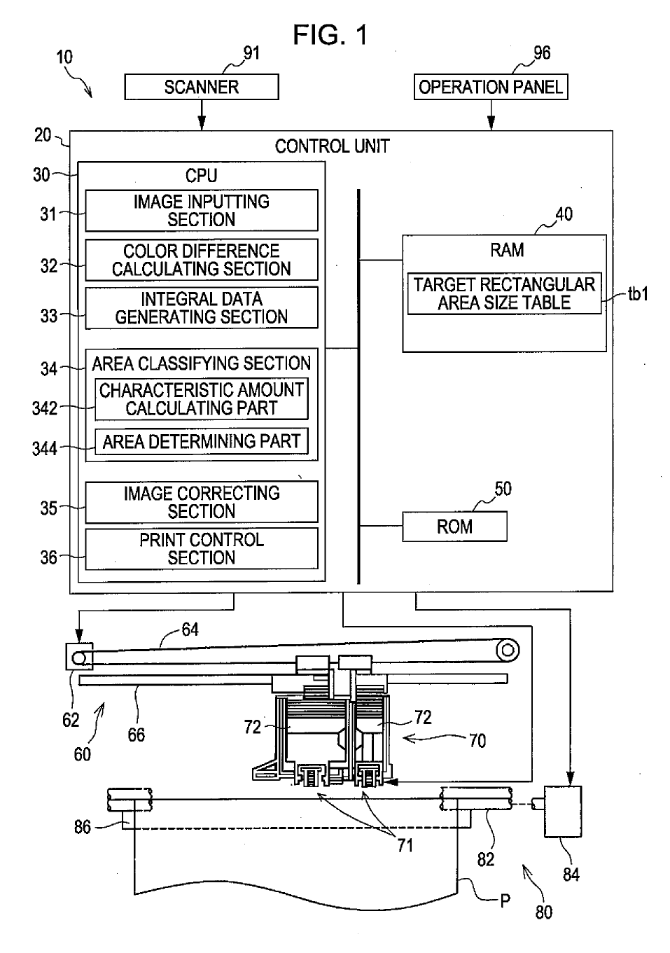

FIG. 1 is an explanatory diagram showing a schematic configuration of a printer (printing apparatus) as an image processing apparatus according to an embodiment of the invention. The printer 10 is so-called a multi-function printer that has a scanning function and a copying function in addition to a printing function. The printer 10 includes a control unit 20, a carriage moving mechanism 60, a carriage 70, a paper transporting mechanism 80, a scanner 91, and an operation panel 96.

The carriage moving mechanism 60 includes a carriage motor 62, a driving belt 64, and a sliding shaft 66. The carriage moving mechanism 60 drives the carriage 70 that is held in the sliding shaft 66 so as to be freely movable in the main scanning direction. The carriage 70 includes an ink head 71 and ink cartridges 72. The carriage 70 ejects ink that is supplied to the ink head 71 from the ink cartridges 72 onto a print sheet P. The paper transporting mechanism 80 includes a paper transporting roller 82, a paper transporting motor 84, and a platen 86. As the paper transporting motor 84 rotates the paper transporting roller 82, the paper transporting mechanism 80 transports a print sheet P along the top face of the platen 86. The scanner 91 is an image scanner that optically reads an image. According to this embodiment, the CCD (charge coupled device) type scanner 91 is used. However, various types of scanners such as a CIS (contact image sensor) type may be used.

The above-described mechanisms are controlled by the control unit 20. The control unit 20 is configured by a micro computer that includes a CPU 30, a RAM 40, and a ROM 50. By expanding a program, which is stored in the ROM 50, into the RAM 40 and executing the program, the control unit 20 serves as an image inputting unit 31 other than controlling the above-described mechanisms. Similarly, the CPU 30 serves as a color difference calculating section 32, an integral data generating section 33, an area classifying section 34, an image correcting section 35, and a print control section 36. In addition, the area classifying section 34 includes a characteristic amount calculating part 342 and an area determining part 344. These function sections will be described later in detail. In the RAM 40, a target rectangular area size table tb1 is stored in advance.

The printer 10 having the above-described configuration serves as a copier by printing an image read out by the scanner 91 on a print sheet P. In addition, the above-described printing mechanism is not limited to a mechanism using the ink jet method. Thus, various printing methods such as a laser method and a thermal transfer method may be used.

The above-described color difference calculating section 32 and the integral data generating section 33 correspond to a sum correspondence value calculating unit according to an embodiment of the invention. In addition, the characteristic amount calculating part 342 corresponds to a rectangle sum value calculating unit according to an embodiment of the invention, the area determining part 344 corresponds to an attribute determining unit according to an embodiment of the invention, and the image inputting section 31 corresponds to a resolution acquiring unit according to an embodiment of the invention.

### A2. IMAGE DUPLICATING PROCESS

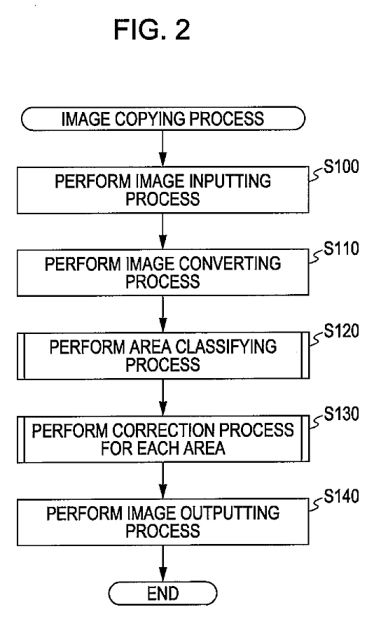

FIG. 2 is a flowchart showing the sequence of an image duplicating process that is performed in the printer 10. This image duplicating process is started by user's setting an image (for example, a document such as a printed material) to be copied to the printer 10 and performing an operation for directing copy using the operation panel 96. When this process is started, the image inputting section 31 converts a formed optical image into an electrical signal by using the scanner 91 (Step S100). The image inputting section 31 converts the acquired analog signal into a digital signal by using an AD converting circuit and performs a shading correction process so as to form the entire image to have the same brightness (Step S110). In addition, at this moment, the image inputting section 31 records the read-out resolution (for example, 300 dpi) in the RAM 40.

The image inputting section 31, the integral data generating section 33, and the area classifying section 34 perform area classification for the acquired image data (also referred to as “target image data”) in units of pixels (Step S120). This process is a process for classifying pixels constituting an image into pixels belonging to a black character area and pixels belonging to a halftone dot area. The process will be described later in detail in the section of “A3. Area Classifying Process”.

Next, the image correcting section 35 performs for each classified area a correction process that is appropriate for the area (Step S130). This process, for example, is a process of performing spatial filtering or the like by using an emphasis filter for pixels classified into the black character area and performing the above-described spatial filtering or the like by using a smoothing filter for pixels classified into the halftone dot area. The correction process will be described in detail later in the section of “A4. Correction Process for Each Area”. By performing such a correction process, in an image outputting process of Step S140 to be described later, an advantage that a portion configuring a black character area is sharpened, a portion configuring the halftone dot is output with a moiré pattern suppressed, and the like can be acquired.

When the correction process for each area is performed, the print control section 36 outputs an image on the printing sheet P by driving the carriage moving mechanism 60, the carriage 70, the paper transporting mechanism 80, and the like (Step S140). As described above, the image duplicating process is completed.

### A3. AREA CLASSIFYING PROCESS

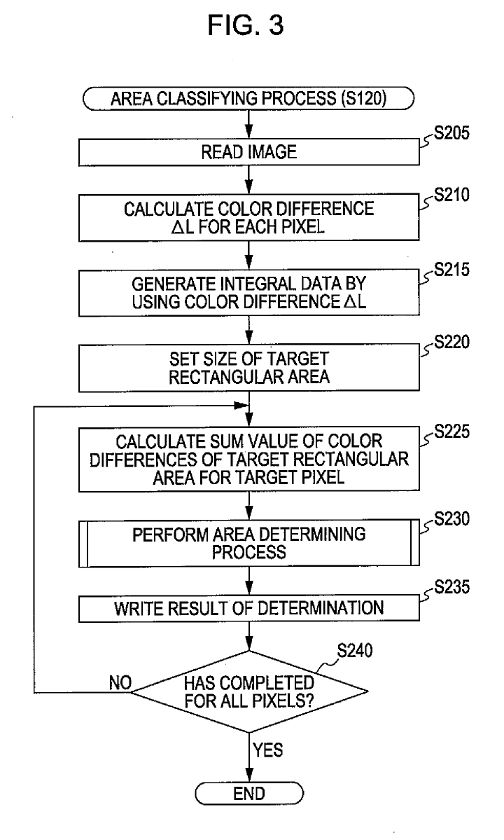

FIG. 3 is a flowchart showing the sequence of the area classifying process that is performed in Step S120 (FIG. 2). When this process is started, the image inputting section 31 reads the image data (here, RGB data) acquired in Step S110 (FIG. 2) in the RAM 40 (Step S205). The color difference calculating section 32 calculates a color difference AL for each pixel by analyzing the target image data (Step S210). Here, the “color difference ΔL” in this embodiment represents the degree of vividness of each pixel (R, G, and B). The color difference ΔL represents the degree of a chromatic color for a case where an achromatic color is denoted by “0”. In particular, the color difference ΔL is represented by the following Equation 1.

Equation 1

ΔL=max (R, G, B)−min (R, G, B)

In the above-described Equation 1, max(R, G, B) represents a largest value among component values of R (red color), G (green color), and B (blue color) that constitute the image data. In addition, min(R, G, B) represents a smallest value among values of R, G, and B. For example, when (R, G, B)=(128, 53, 28), the color difference ΔL becomes 100 (128−28).

Here, for an achromatic color, all the values of R, G, and B are the same with one another. For example, (R, G, B)=(0, 0, 0) for a completely black color, (R, G, B)=(128, 128, 128) for a gray color having medium brightness, and (R, G, B)=(255, 255, 255) for a completely white color. Accordingly, as the color becomes relatively close to an achromatic color and the saturation is decreased, all the values of R, G, and B become values of a same degree. Therefore, in such a case, the color difference ΔL is decreased. On the contrary, as the saturation is increased, at least two values of the values of R, G, and B become greatly different from each other. Accordingly, in such a case, the color difference ΔL is increased. In addition, the color difference ΔL corresponds to a “saturation evaluating value” according to an embodiment of the invention.

The integral data generating section 33 generates integral data by using the color difference ΔL that is acquired in Step S215 (Step S215). In particular, the integral data generating section 33 selects a target pixel sequentially from among the pixels, calculates an integral value (integral value of the color difference) of the color difference ΔL, to be described later, for the target pixel, and stores the integral value of the color difference in the RAM 40. When Step S215 is performed for the first time, the integral data generating section 33 selects a pixel that is located on the upper left corner of the image as the target pixel. Then, when the integral value of the color differences for this pixel is generated, the integral data generating section 33 selects a pixel located to the right side thereof as the target pixel and calculates an integral value of the color difference. As described above, the integral data generating section 33 calculates the integral values of the color differences while sequentially switching the target pixel from the pixel located on the upper left corner to the pixel located on the lower right corner and stores the integral values of the color differences in the RAM 40. Here, the integral values of the color differences for all the pixels that are stored in the RAM 40 are referred to as “integral data”. In addition, when reading of the image data is performed in units of bands, the integral data may be generated in units of the bands. The above-described “integral data” corresponds to a “sum correspondence value” according to an embodiment of the invention.

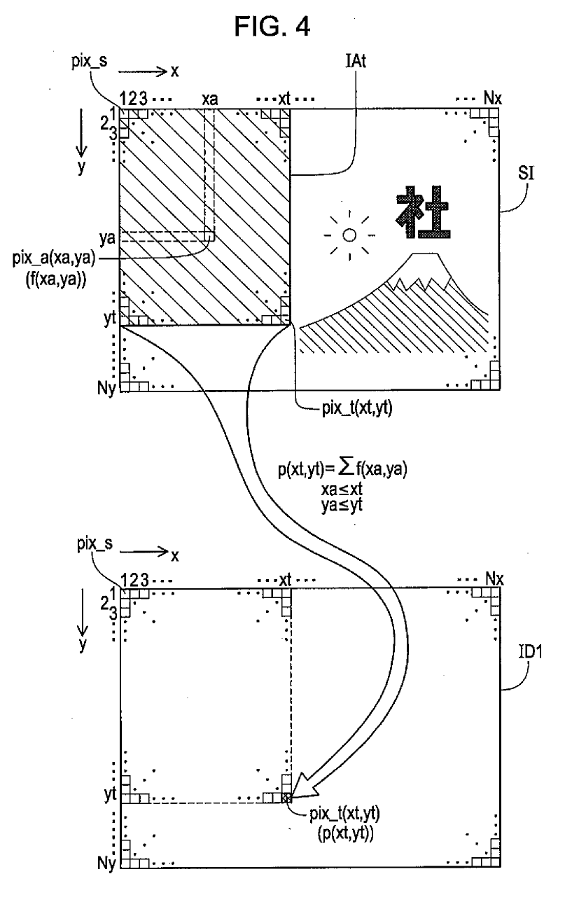

FIG. 4 is an explanatory diagram schematically showing a method of generating the integral data in Step S215. An upper part of FIG. 4 schematically shows target image data SI, and a lower part thereof schematically shows the integral data ID1 that is generated from the target image data SI. In addition, a pixel located xa-th in direction x and ya-th in direction y from a reference pixel (in this embodiment, pix_s) is denoted by pix_a(xa, ya). In addition, the color difference ΔL of the pixel is denoted by f(xa, ya. Here, the range of xa is 1 to Nx, and the range of ya is 1 to Ny (Nx and Ny are integers that are determined based on the resolution of the target image data SI). Here, the integral value p(xt, yt) of the color difference for a pixel pix_t (xt, yt) is represented by the following Equation 2.

$$\begin{matrix}Equation 2 & \\ p ( xt , yt ) = {\sum }_{xa \leq xt , ya \leq yt} f ( xa , ya ) & ( 2 )\end{matrix}$$

This integral value p(xt, yt) of color differences represents a sum value of the color differences ΔL within a rectangular area IAt in which two pixels including the reference pixel pix_s(0, 0) and a pixel pix_t(xt, yt) become diagonal pixels (in FIG. 4, the rectangular area IAt is hatched). The integral data generating section 33 calculates the integral value p(xt, yt) of the color differences for each pixel by using Equation 2 described above and generates the integral data ID1.

When the integral data is generated, the characteristic amount calculating part 342 (FIG. 1) sets the size of the target rectangular area based on the read-out resolution at the time of scanning by referring to the target rectangular area size table tb1 (FIG. 3: Step S220).

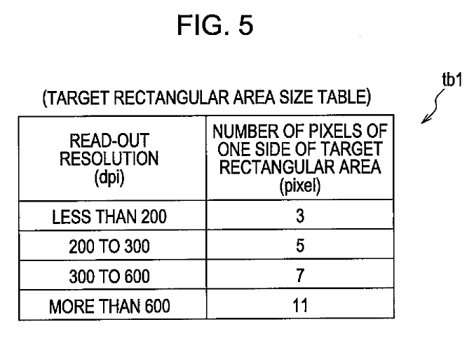

FIG. 5 is an explanatory diagram schematically showing the content of the target rectangular area size table tb1. The “target rectangular area” represents an area that is referred to at the time when an area (a black character area or a halftone dot area) to which a target pixel belongs is classified in the area determining process for the target pixel to be described later. In the target rectangular area size table tb1, the size (the number of pixels for each side) of the target rectangular area is set based on the read-out resolution at the time of scanning. In particular, the resolution is divided into four levels, and the number of pixels is set to be increased for a higher level of the resolution. The reason for the above-described setting is as follows. When an area of a same size is read out with higher resolution from an image (document) to be copied, the number of pixels that represent the area is increased. Accordingly, when the size of the target rectangular area set as described above is used, the area to which each pixel belongs can be classified by referring to a target rectangular area of an almost same size even for a case where reading out is performed with any resolution. Therefore, it can be suppressed that the precision of classification of the area to which a pixel belongs is changed based on the read-out resolution.

When the size of the target rectangular area is set, the characteristic amount calculating part 342 selects one pixel as a target pixel and calculates a sum value (hereinafter, referred to as a “sum value of color differences within the area”) of the color differences within the target rectangular area for the target pixel (FIG. 3: Step S225). In addition, when Step S225 is performed for the first time, the characteristic amount calculating part 342 determines a pixel pix_s located on the upper right corner as the target pixel.

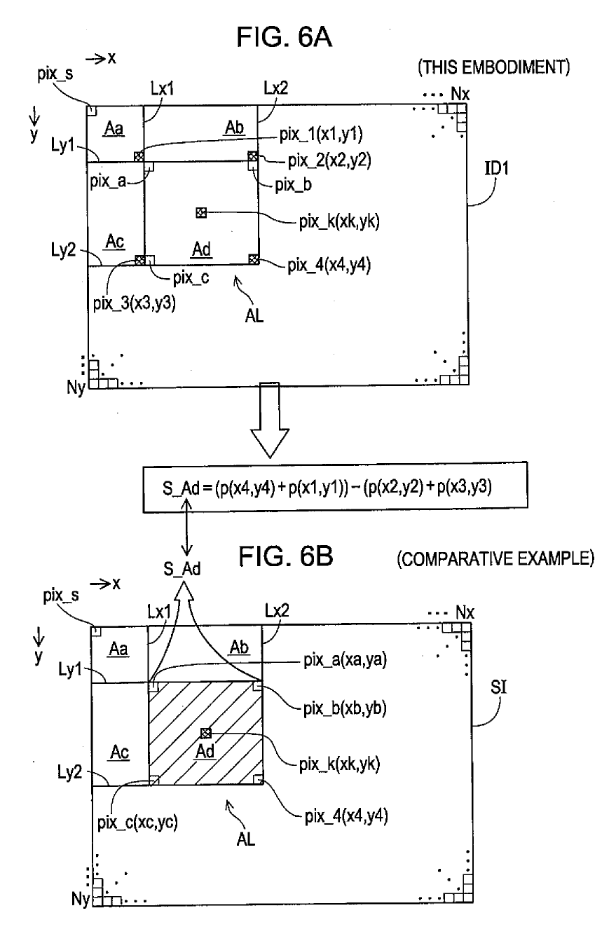

FIGS. 6A and 6B are explanatory diagrams schematically showing methods of calculating a sum value of color differences within the area. FIG. 6A shows a method of calculating the sum value of color differences within the area according to this example, and FIG. 6B shows a method of calculating a sum value of color differences within the area according to a comparative example. In FIGS. 6A and 6B, the integral data ID1 and the target image data SI are the same as those shown in FIG. 4 described above.

In the examples shown in FIGS. 6A and 6B, methods of calculating the sum value S_Ad of color differences within the area for a pixel pix_k (xk, yk) by using a rectangular area Ad as the target rectangular area is represented. Here, the rectangular area Ad is a square area that has the center at the pixel pix_k (xk, yk) and is surrounded by inter-pixel boundary lines Lx1, Lx2, Ly1, and Ly2. This rectangular area Ad has pixels pix_a, pix_b, pix_c, and pix_4 (x4, y4) on four corners thereof. The size of this rectangular area Ad will be described later.

Here, in a position adjacent to a pixel pix_a with a vertex of the rectangular area Ad, which is located on the upper left corner, interposed therebetween, a pixel pix_1 (x1, y1) is located. In addition, in a position adjacent to a pixel pix_b, which is located on the upper right corner of the rectangular area Ad, in direction of −y with a boundary line Ly1 interposed therebetween, a pixel pix_2 (x2, y2) is located. In a position adjacent to a pixel pix_c, which is located on the lower left corner of the rectangular area Ad, in direction −x with a boundary line Ly2 interposed therebetween, a pixel pix_3 (x3, y3) is located. In addition, a pixel pix_4 (x4, y4) is located on the lower right corner of the rectangular area Ad. According to this embodiment, the sum value S_Ad of color differences within the area is calculated by the following Equation 3 by using integral values (p(x1, y1), p(x2, y2), p(x3, y3), and p(x4, y4)) of color differences of the above-described four pixels pix_1 to pix_4 that are adjacent to vertexes of the rectangular area Ad.

Equation 3

S_{—}Ad=(p(x4, y4)+p(x1, y1))−(p(x2, y2)+p(x3, y3))

(S_Ad: sum value of color differences within the area Ad)

As shown in FIG. 6, a rectangular area ΔL in which the pixel pix_s and the pixel_4 are diagonal pixels is configured by three rectangular areas Aa, Ab, and Ac together with the above-described rectangular area Ad. Here, the pixel pix_1 is a pixel that is located at an opposite angle with respect to a pixel pix_s in a rectangular area Aa that has a vertex located on the upper left corner of the rectangular area Ad as its vertex and has the reference pixel pix_s located on its corner. Accordingly, an integral value p(x1, y1) of color differences is calculated by summing the color differences ΔL of all the pixels that are included in the rectangular area Aa. Similarly, an integral value p(x2, y2) of color differences is calculated by summing the color differences ΔL of all the pixels that are included in the rectangular areas Aa and Ab, an integral value p(x3, y3) of color differences is calculated by summing the color differences ΔL of all the pixels that are included in the rectangular areas Aa, Ac, and an integral value p(x4, y4) of color differences is calculated by summing the color differences ΔL of all the pixels that are included in the rectangular areas Aa, Ab, Ac, and Ad (that is, a rectangular area AL). Accordingly, the sum value of color differences ΔL of all the pixels that are included only in the rectangular area Ad can be acquired by using the above-described Equation 3.

Even when one side 11 of the rectangular area Ad is a square area of pixels, the integral value p of color differences calculated in the above-described Step S215 for four pixels (pix_1, pix_2, pix_3, and pix_4) can be acquired from the RAM 40 in a calculation process by using the above-described Equation 3. Therefore, the calculation process is completed by four times of accessing the memory.

On the other hand, as shown in the comparative example (FIG. 6B), in a case where the sum value S_Ad of color differences within the area is calculated by adding color differences ΔL of all the pixels within the rectangular area Ad, when one side 11 of the rectangular area Ad is the square area of pixels, a total of 121 times of accessing the memory are performed. The above-described sum value S_Ad of color differences within the area corresponds to a “sum value within the rectangular area” according to an embodiment of the invention.

When the sum value of color differences within the area is calculated, the area determining part 344 (FIG. 1) performs a process (area determining process) for determining whether the target pixel belongs to the black character area or the halftone dot area (FIG. 3: Step S230).

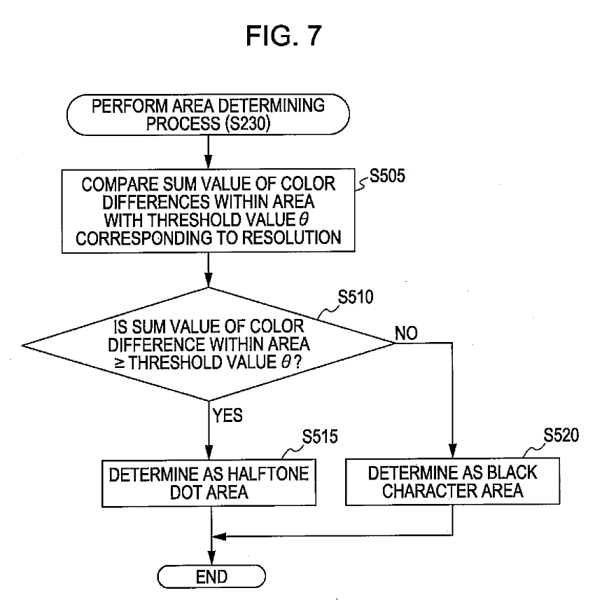

FIG. 7 is a flowchart showing a detailed sequence of the area determining process (Step S230) shown in FIG. 3. The area determining part 344 determines whether the sum value S_Ad of color differences within the area is equal to or larger than a threshold value θ (Step S510) by comparing the sum value S_Ad of color differences within the area calculated in Step S225 with the threshold value θ that is set in advance in accordance with the read-out resolution (Step S505). When the sum value S_Ad of color differences within the area is equal to or larger than the threshold value θ, the area determining part 344 determines the target pixel to be a pixel belonging to the “halftone dot area” (Step S515). On the other hand, when the sum value S_Ad of color differences within the area is smaller than the threshold value θ, the area determining part 344 determines the target pixel to be a pixel belonging to the “black character area” (S520).

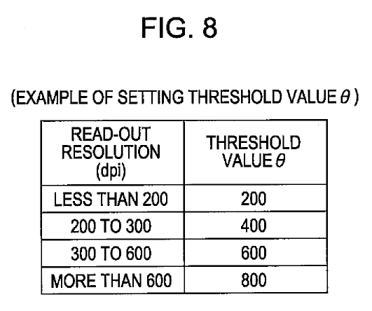

FIG. 8 is an explanatory diagram showing a setting example of the threshold value θ that is referred to in Step S505. In the example shown in FIG. 8, similar to the target rectangular area size table tb1 (FIG. 5), four levels are set in accordance with the read-out resolution, and threshold values θ are set for the levels. As the read-out resolution becomes higher, the threshold value θ is increased. The reason is that as the resolution becomes higher, the number of pixels within the target rectangular area is increased, and the sum value S_Ad of color differences within the area may be increased further. The threshold values θ are calculated in advance through experiments and experiences by analyzing a plurality of images.

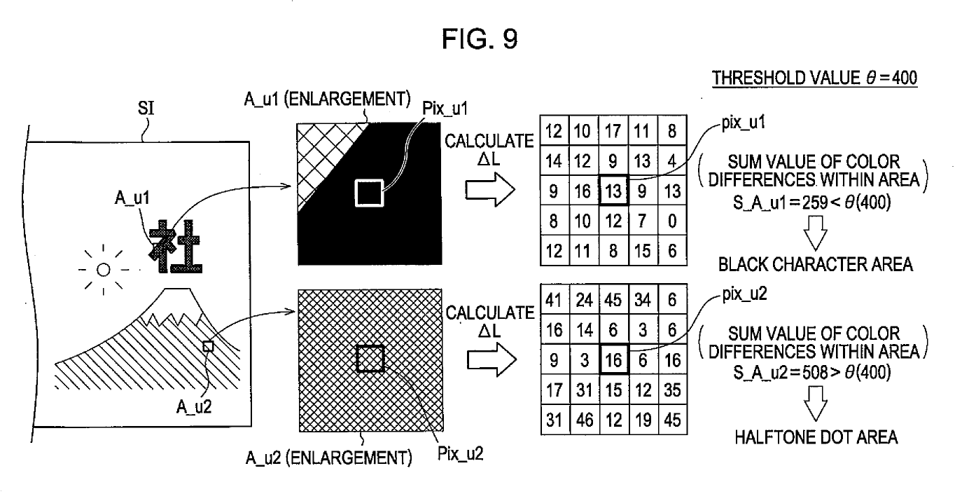

FIG. 9 is an explanatory diagram showing one example of the result of area classification. The target image data SI that is the same as shown in FIG. 4 is shown on the leftmost side in FIG. 9. In the example shown in FIG. 9, the results of area classification for a pixel Pix_u1 of the target image data SI which is located within the black character area and a pixel Pix_u2 located within the halftone dot area are shown. In FIG. 9, a target rectangular area A_u1 of the pixel Pix_u1 and a target rectangular area A_u2 of the pixel Pix_u2 are enlarged. In addition, it is assumed that the read-out resolution of the target image data SI is 300 dpi, and the threshold value θ=400 (FIG. 8).

Most of the target rectangular area A_u1 corresponds to the black character portion except for an upper left part thereof, and accordingly, a difference in color differences ΔL for the pixels has a relatively small value. In addition, the sum value S_A_u1 of color differences within the area is “259”. On the other hand, a target rectangular area A_u2 corresponds to the halftone dot area, and accordingly, pixels of achromatic colors and pixels of chromatic colors are mixed therein. Therefore, a difference in the color differences ΔL of the pixels is large. In addition, the sum value S_A_u2 of color differences within the area is “508”. In the area determining process (FIG. 7), the threshold value θ=400 (FIG. 8) that is set for the read-out resolution of 300 dpi and the sum value S_A_u1 of color differences within the area are compared with each other. Since the sum value S_A_u1 of color differences within the area is smaller than the threshold value θ (400), the pixel Pix_u1 is determined to belong to the black character area. On the other hand, since the sum value S_A_u2 of color differences within the area is larger than the threshold value θ (400), the pixel Pix_u2 is determined to belong to the halftone dot area. As a result, the pixels Pix_u1 and Pix_u2 are classified correctly.

When the area determining process is completed, the area determining part 344 writes the result of determination for the area, to which the target pixel belongs, into the RAM 40 (FIG. 3: Step S235). The characteristic amount calculating part 342 determines whether the area determining process for all the pixels as the target pixels has been completed (Step S240). When there is any remaining pixel, the characteristic amount calculating part 342 performs the above-described Step S225 with the next pixel set as the target pixel. When the area determining process is completed for all the pixels as the target pixels, the area classifying process is completed, and the correction process for each area (FIG. 2: Step S130) is performed.

### A4. CORRECTION PROCESS FOR EACH AREA

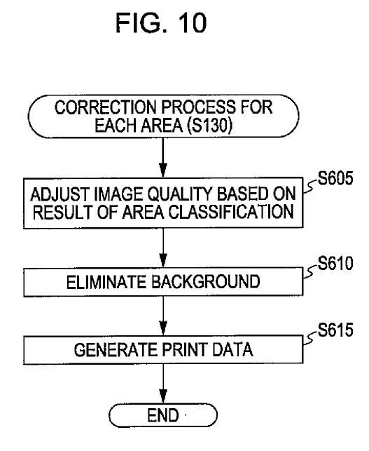

FIG. 10 is a flowchart showing a detailed sequence of the above-described correction process for each area (FIG. 2: Step S130). When this process is started, the image correcting section 35 adjusts the image quality for each area (the black character area and the halftone dot area) based on the result of the above-described area classifying process (FIG. 3) (Step S605). In this process, for example, calculation of a matrix (spatial filtering) in which predetermined weighting factors are set as general technology may be performed. In particular, in performing the spatial filtering, an emphasis filter is used for pixels classified as the black character area so as to sharpen the character, and a smoothing filter is used for pixels classified as the halftone dot area. Accordingly, smoothing and moiré patterns are eliminated.

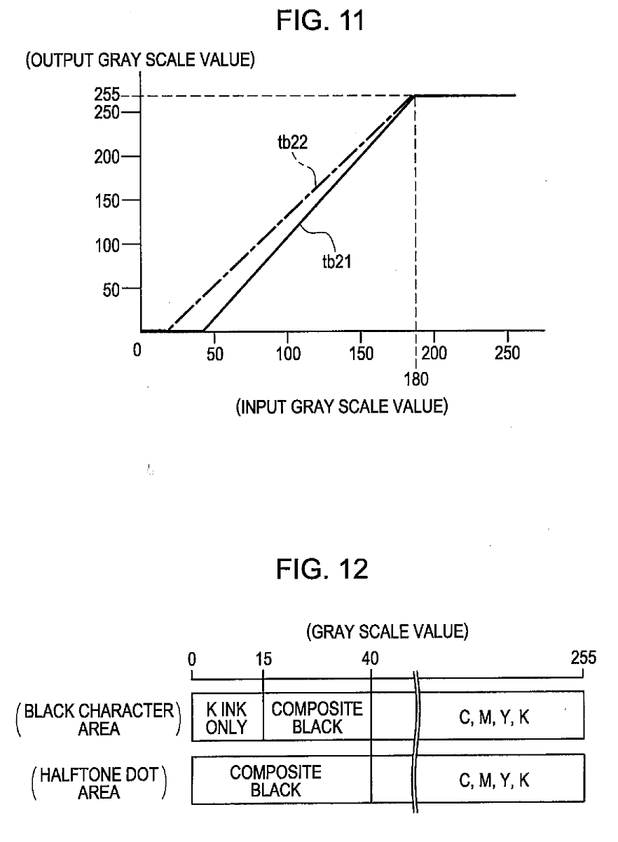

Next, the image correcting section 35 performs a linear conversion of the gray scale value based on the result of the above-described area classifying process (FIG. 3) so as to perform so-called background elimination (Step S610). FIG. 11 is an explanatory diagram showing one example of a conversion table that is used in Step S610; In FIG. 11, the horizontal axis denotes an input gray scale value, and the vertical axis denotes an output gray scale value.

In the printer 10, a black character area table tb21 and a halftone dot area table tb22 are set as the conversion tables that are used for background elimination. Thus, the linear conversion of the gray scale value is performed based on these conversion tables. Here, in any table tb21 or tb22, when the input gray scale value is equal to or larger than 180, the output gray scale value is “255”. Accordingly, in a case where the brightness of an area of a scanned image that corresponds to a white portion of a document is not sufficiently high, even when the area is formed in a thin gray color other than the white color, the area can be output in the white color. In addition, a linear conversion process having a steep slope is performed based on the black character area table tb21, and accordingly, the contrast can be increased. On the other hand, a linear conversion process having a gentle slope is performed based on the halftone dot area table tb22, and accordingly, the continuity for the intermediate gray scales can be maintained.

Next, the image correcting section 35 generates print data based on the image data for which the process of Step S610 has been performed (FIG. 10: Step S615). In particular, the image correcting section 35 converts the gray scale values (R, G, and B) of each pixel into dot data of C (cyan), M (magenta), Y (yellow) and K (black) as colors of ink. Here, in the printer 10, for representing the black color, there are a case where only the ink of K is used and a case where a composite black color (a black color of mixed colors of C, M, Y, and K) is used. The method of representing the black color is determined in advance in accordance with the gray scale value for each area (the black character area and the halftone dot area).

FIG. 12 is an explanatory diagram showing a setting of ink types used in the printer 10. In the figure, the horizontal axis denotes a gray scale value. For a pixel of the black character area, a setting in which only the ink K (black) is used for the range, in which the gray scale value is equal to or smaller than 15, is used, and a setting in which the composite black color is used for the range, in which the gray scale value is equal to or larger than 16 and equal to or smaller than 40, is used. Accordingly, the density of the black character portion can be increased, and whereby a character can be printed sharply.

On the other hand, for the halftone dot area, a setting in which the composite black color is used for the range, in which the gray scale value is equal to or smaller than 40, is used. Accordingly, natural color shading can be represented by suppressing a feeling of granularity even for a dark portion located within an image.

As described above, the sum value S_Ad of color differences within the area that is used for determining the attribute of each pixel is calculated in the printer 10, and accordingly, four times of accessing the memory is made regardless of the size of the target rectangular area. Therefore, the process load of the CPU 30 for performing the area determining process can be decreased. In addition, the above-described area classifying process is configured by simple calculation processes, and accordingly, the process can be implemented in software at a low cost. In addition, since the area classifying process is configured by combining simple calculation processes, the process can be implemented as a parallel process having the SIMD (single instruction multiple data) feature. Accordingly, the process can be performed at a high-speed. For example, reading of the image data and area classification (determination) may be performed in a parallel manner. In addition, since the attribute (the black character area and the halftone dot area) of each pixel is determined, the image correcting process can be performed in accordance with the attributes. In addition, by determining the target rectangular area in accordance with the read-out resolution, the attribute of each pixel can be determined by referring to an area having almost the same size regardless of the degree of the read-out resolution. Accordingly, the accuracy of determination (classification) can be maintained to be almost constant regardless of the read-out resolution. In addition, the use or non-use of the ink K (black) is determined in accordance with the attribute and the gray scale value, and accordingly, a printing (image duplicating) process can be performed such that the density of the black character portion is increased, and natural color shading is represented in the image.

### B. MODIFIED EXAMPLE

The invention is not limited to the embodiment or the example described above. Thus, the invention may be performed in various forms within the scope not departing from the general intentions described above. For example, the following modifications can be made.

### B1. MODIFIED EXAMPLE 1

In the above-described embodiment, the color difference ΔL, as shown in the above-described Equation 1, is calculated as a difference between a maximum value and a minimum value of values of R (red color), G (green color), and B (blue color). However, alternatively, the color difference ΔL may be calculated as an average value of differences of the colors (a difference between R and G, a difference between R and B, and a difference between G and B). Even in such a case, when the acquired color difference ΔL is large, the saturation is high. On the other hand, when the acquired color difference ΔL is small, the saturation is low. Thus, the color difference ΔL can be used as an indicator for classifying the black character area and the halftone dot area. In addition, although the accuracy of classification is lowered, one difference among the above-described three differences may be used as the color difference ΔL. In other words, a value that is calculated based on a difference of at least two values from among R, G, and B may be used as a saturation evaluating value of an image processing apparatus according to an embodiment of the invention.

### B2. MODIFIED EXAMPLE 2

In the above-described embodiment, the image data is data that is represented in a display color system of R, G, and B. However, the image data may be data that is represented in a different display color system. For example, the image data may be data of an L*a*b* display color system. In such a case, for example, a case where values in the a* axis and the b* axis are large represents high saturation, and accordingly, the color difference ΔL can be calculated based on the values. In other words, generally, any arbitrary evaluation value relating to the saturation may be used as the saturation evaluating value in the image processing apparatus according to an embodiment of the invention.

### B3. MODIFIED EXAMPLE 3

The target rectangular area size table tb1 (FIG. 5) in the above-described embodiment is merely one example of a combination of the read-out resolution and the size (the number of included pixels) of the target rectangular area, and thus, any other combination may be used. For example, a same value (size) may be used for all the resolutions. In addition, regardless of the read-out resolution, a plurality of integral values of color differences may be calculated for each pixel by using rectangular areas of a plurality of predetermined sizes as the target rectangular areas. For example, an integral value of color differences of a 3×3 pixel area, an integral value of color differences of a 5×5 pixel area, and an integral value of color differences of an 11×11 pixel area may be calculated for each pixel. In such a case, it may be configured that the sum value S_Ad of color differences within each area is calculated for each size of the target rectangular areas for each pixel, and the attribute of the area is determined based on a plurality of sum values S_Ad of color differences within the area. In such a case, the accuracy of classification of the attribute of the area can be improved. Here, the shape of the target rectangular area is not limited to a square. Thus, as the target rectangular area, a rectangle having different lengths in the vertical and horizontal directions may be used. In other words, generally, an area surrounded by any arbitrary target rectangle that is configured by boundary lines of pixels in the image data may be used as the target rectangular area in the image processing apparatus according to an embodiment of the invention.

### B4. MODIFIED EXAMPLE 4

In the above-described embodiment, the integral data is a sum value of color differences ΔL within a rectangular area for each pixel in which two pixels including the pixel and the reference pixel become diagonal pixels. However, alternately, various values corresponding to the sum value of color differences ΔL may be used as the integral data. For example, a value (that is, an average value) acquired from dividing the integral value p(xt, yt) of color differences for each pixel by a total number of pixels of the rectangular area may be used. In such a case, the capacity of the memory that is needed for storing the integral data can be reduced greatly. Also in such a case, the total number of pixels can be determined in an easy manner based on the positions of the pixels, and accordingly, the integral data generating section 33 can calculate the integral value p(xt, yt) of color differences in an easy manner based on each pixel value (average value) of the integral data.

### B5. MODIFIED EXAMPLE 5

In the above-described embodiment, the value used in the area determining process is the sum value S_Ad of color differences within the area. However, instead of the sum value of color differences, any arbitrary value correlated with the sum value of color differences ΔL within the target rectangular area may be used. For example, when the integral data is a value (that is, an average value) acquired from dividing the integral value p(xt, yt) of color differences for each pixel by the total number of pixels of the rectangular area, a sum value of average values of integral values p of color differences within the target rectangular area may be used in the area determining process. In addition, in the area determining process, instead of comparing the sum value S_Ad of color differences within the area with the threshold value θ, any other arbitrary method may be used for determining the area. For example, a lookup table that represents correspondence relationship between the sum value S_Ad of color differences within the area and the attribute may be used. The above-described lookup table may be determined in advance through experiments and experiences by analyzing a plurality of images.

### B6. MODIFIED EXAMPLE 6

In the above-described embodiment, there are two types (the black character area and the halftone dot area) of areas that can be classified. However, instead of two types of areas described above, any arbitrary type may be used. For example, a black character internal portion, an edge portion of a black character, a halftone dot portion, a photo image portion, and the like may be used. In addition, the image processing performed based on the calculated result by using the integral data is not limited to the attribute determining process. Thus, various types of image processing relating to the target rectangular area may be used. For example, a process for adjusting the brightness or the contrast of the rectangular area that is designated by a user may be performed. A process performed for each classified area (attribute) is not limited to the image correcting process (image-quality adjusting process), and various processes may be used as the process performed for each classified area. For example, data may be compressed at different compressing ratios in accordance with the attributes.

In addition, the use of the gray scale value data after the image processing performed based on the calculated result by using the integral data is not limited to a printing process, and various uses may be employed as the use of the gray scale value data. For example, an image may be displayed in a display device, or a data file including the image data may be provided to the user. In such a case, an image after the correction process performed for each attribute may be displayed in a display. In addition, a data file including the gray scale value data after the correction process performed for each attribute may be provided to the user. In addition, a data file including image data to which a flag representing the attribute of each pixel is added may be provided to the user.

### B7. MODIFIED EXAMPLE 7

In the above-described embodiment, the sum value S_Ad of color differences within the area is calculated by using the integral values p of color differences of four pixels pix_1 to pix_4. However, instead of the above-described four pixels, an integral value p of color differences for a different pixel may be used. For example, an integral value p(x1+1, y1) of color differences for a pixel, instead of the pixel pix_1(x1, y1), that is apart to the right side from the pixel pix_1 (x1, y1) by one pixel may be used. In addition, for example, an integral value p(x2, y2+1) of color differences for a pixel, instead of the pixel pix_2 (x2, y2), that is apart to the lower side from the pixel pix_2(x2, y2) by one pixel may be used. Under such a configuration, as the sum value S_Ad of color differences within the area, an accurate value cannot be calculated. However, the sum value S_Ad of color differences within the area can be calculated with decreased error, and accordingly, the area determining process can be performed almost correctly. In other words, generally, a configuration in which integral values p of color differences calculated for each pixel adjacent to four vertexes of the target rectangular area are used for calculating the sum value S_Ad of color differences within the area may be employed to an image processing apparatus according to an embodiment of the invention.

### B8. MODIFIED EXAMPLE 8

In the above-described embodiment, the target image data SI has a rectangular shape. However, an image having any arbitrary shape other than the rectangle may be used. For example, the target image data SI may be circle-shaped or oval-shaped. Even in such a case, by performing the area determining process for any arbitrary rectangular area within the image, an embodiment of the invention may be applied thereto. For example, when a setting in which the image processing is not performed for pixels located near the edge of the image is used in advance, the image processing may be performed by performing the area determining process only for the rectangular area located on the center of the image.

### B9. MODIFIED EXAMPLE 9

In the above-described embodiment, as the image processing apparatus, a multi-function printer has been described as an applied example. However, an image processing apparatus according to an embodiment of the invention may be applied to various digital apparatuses other than the multi-function printer such as a printer having only the printing function, a digital copier, and an image scanner. In addition, the invention is not limited to the configuration as an image processing apparatus. Thus, the invention may be realized in the form of a determination method for determining attributes relating to the types of the image area represented by the pixel, a computer program, or the like.

### B10. MODIFIED EXAMPLE 10

In the above-described embodiment, a part of the configuration that is implemented in hardware may be changed so as to be implemented in software. In addition, a part of the configuration that is implemented in software may be changed to be implemented in hardware.

When a part of or the whole function according to an embodiment of the invention is implemented in software, the software (computer program) may be provided in the form in which the software is stored in a computer-readable recording medium. The “computer-readable recording medium” in descriptions here is not limited to a portable recording medium such as a flexible disc or a CD-ROM and includes various internal memory devices such as a RAM and a ROM that are installed inside a computer and an external memory device such as a hard disk that is fixed to the computer.

The entire disclosure of Japanese Patent Application No. 2008-185241, filed Jul. 16, 2008 is expressly incorporated by reference herein.

What is claimed is:

1. A printing apparatus that prints an image constituted by a plurality of pixels, the printing apparatus comprising:
a sum correspondence value calculating unit that calculates a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel;
a rectangle sum value calculating unit that calculates a sum value within the rectangle on the basis of the sum correspondence value for adjacent pixels that are adjacent to four vertexes of an arbitrary target rectangle of the image for a target pixel located in a predetermined position within the target rectangle;
an attribute determining unit that determines the attribute of the target pixel in the image based on the sum value within the rectangle for the target pixel; and
a print control unit that prints image data for which image processing on the basis of the attributes of the pixels is performed.

2. The printing apparatus according to claim 1,
wherein the image is a rectangle, and
wherein the reference pixel is a pixel that is located in any one of the vertexes of four corners of the image.

3. The printing apparatus according to claim 1, wherein the attribute determining unit determines to which area of a plurality of types of areas, which includes at least a black character area and a halftone dot area of the image, the target pixel belongs.

4. The printing apparatus according to claim 1,
wherein the pixel is represented by tone data that has component values of R (red color), G (green color), and B (blue color), and
wherein the sum correspondence value calculating unit calculates the saturation evaluating value based on a difference of at least two component values among the component values.

5. The printing apparatus according to claim 4, wherein the sum correspondence value calculating unit calculates the saturation evaluating value based on a difference between a maximum value and a minimum value among the component values.

6. The printing apparatus according to claim 1, further comprising a resolution acquiring unit that acquires the resolution of the image,
wherein, in a case where the resolution of the image is higher than a specific value, the rectangle sum value calculating unit calculates the sum value within the rectangle by setting the number of the pixels within the target rectangular area to be larger than that for a case where the resolution of the image is lower than the specific value, based on the resolution.

7. The printing apparatus according to claim 1, further comprising:
a resolution acquiring unit that acquires the resolution of the image; and
a print control unit that prints image data for which image processing on the basis of the attributes of the pixels is performed,
wherein the image is a rectangle,
wherein the reference pixel is a pixel that is located in any one of vertexes on four corners of the image,
wherein the pixel is represented by tone data that has component values of R (red color), G (green color), and B (blue color),
wherein the sum correspondence value calculating unit calculates the saturation evaluating value based on a difference between a maximum value and a minimum value among the component values,
wherein, in a case where the resolution of the image is higher than a specific value, the rectangle sum value calculating unit calculates the sum value within the rectangle by setting the number of the pixels within the target rectangular area to be larger than that for a case where the resolution of the image is lower than the specific value, based on the resolution, and
wherein the attribute determining unit determines to which area of a plurality of types of areas, which includes at least a black character area and a halftone dot area of the image, the target pixel belongs.

8. A printing method using a printing apparatus that prints an image constituted by a plurality of pixels, the method comprising:
calculating a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel;
calculating a sum value within the rectangle on the basis of the sum correspondence value for adjacent pixels that are adjacent to four vertexes of an arbitrary target rectangle of the image for a target pixel located in a predetermined position within the target rectangle;
determining the attribute of the target pixel in the image based on the sum value within the rectangle for the target pixel; and
printing image data for which image processing on the basis of the attributes of the pixels is performed.

9. The printing method according to claim 8,
wherein the image is a rectangle, and
wherein the reference pixel is a pixel that is located in any one of the vertexes of four corners of the image.

10. The printing method according to claim 8, wherein to which area of a plurality of types of areas, which includes at least a black character area and a halftone dot area of the image, the target pixel belongs is determined in the determining of the attribute of the target pixel.

11. The printing method according to claim 8,
wherein the pixel is represented by tone data that has component values of R (red color), G (green-color), and B (blue color), and
wherein the saturation evaluating value is calculated based on a difference of at least two component values among the component values in the calculating of the sum correspondence value.

12. The printing method according to claim 11, wherein the saturation evaluating value is calculated based on a difference between a maximum value and a minimum value among the component values in the calculating of the sum correspondence value.

13. The printing method according to claim 8, further comprising acquiring the resolution of the image,
wherein, in a case where the resolution of the image is higher than a specific value, the sum value within the rectangle is calculated by setting the number of the pixels within the target rectangular area to be larger than that for a case where the resolution of the image is lower than the specific value, based on the resolution in the calculating of the sum value within the rectangle.

14. The printing method according to claim 8, further comprising:
acquiring the resolution of the image; and
printing image data for which image processing on the basis of the attributes of the pixels is performed,
wherein the image is a rectangle;
wherein the reference pixel is a pixel that is located in any one of vertexes on four corners of the image,
wherein the pixel is represented by tone data that has component values of R (red color), G (green color), and B (blue color),
wherein the saturation evaluating value is calculated based on a difference between a maximum value and a minimum value among the component values in the calculating of the sum correspondence value,
wherein, in a case where the resolution of the image is higher than a specific value, the sum value within the rectangle is calculated by setting the number of the pixels within the target rectangular area to be larger than that for a case where the resolution of the image is lower than the specific value, based on the resolution in the calculating of the sum value within the rectangle, and
wherein to which area of a plurality of types of areas, which includes at least a black character area and a halftone dot area of the image, the target pixel belongs is determined in the determining of the attribute of the target pixel.

15. A medium having a computer program for printing an image, which is constituted by a plurality of pixels, recorded thereon, the computer program implementing in a computer functions comprising:
a function for calculating a sum correspondence value on the basis of a sum value of saturation evaluating values of pixels located within a rectangle in which a corner adjacent to an arbitrary pixel within the image and a corner adjacent to a reference pixel within the image become opposing corners for the arbitrary pixel;
a function for calculating a sum value within the rectangle on the basis of the sum correspondence value for adjacent pixels that are adjacent to four vertexes of an arbitrary target rectangle of the image for a target pixel located in a predetermined position within the target rectangle;
a function for determining the attribute of the target pixel in the image based on the sum value within the rectangle for the target pixel; and
a function for printing image data for which image processing on the basis of the attributes of the pixels is performed.

16. The medium according to claim 15,
wherein the image is a rectangle, and
wherein the reference pixel is a pixel that is located in any one of the vertexes of four corners of the image.

17. The medium according to claim 15, wherein the function for determining the attribute of the target pixel is determining to which area of a plurality of types of areas, which includes at least a black character area and a halftone dot area of the image, the target pixel belongs.

18. The medium according to claim 15,
wherein the pixel is represented by tone data that has component values of R (red color), G (green color), and B (blue color), and
wherein the function for calculating the sum correspondence value is calculating the saturation evaluating value based on a difference of at least two component values among the component values.

19. The medium according to claim 18, wherein the function for calculating the sum correspondence value is calculating the saturation evaluating value based on a difference between a maximum value and a minimum value among the component values.

20. The medium according to claim 15, further comprising a function for acquiring the resolution of the image,
wherein, in a case where the resolution of the image is higher than a specific value, the function for calculating the sum value within the rectangle is calculating the sum value within the rectangle by setting the number of the pixels within the target rectangular area to be larger than that for a case where the resolution of the image is lower than the specific value, based on the resolution.
